(19) United States
(12) Patent Application Publication
(10) Pub. No.: US 2021/0142343 A1
(43) Pub. Date: May 13, 2021

(54) Automated Questionnaire Population

(71) Applicant: ProcessBolt, Inc., Minnetonka, MN (US)

(72) Inventors: Dan Gardner, Edina, MN (US); Gaurav Gaur, Maple Grove, MN (US); Ryan McArthur, Plymouth, MN (US)

(21) Appl. No.: 17/091,850

(22) Filed: Nov. 6, 2020

Related U.S. Application Data
(60) Provisional application No. 62/931,986, filed on Nov. 7, 2019.

(51) Int. Cl. G06Q 30/02; G06Q 10/10; G06F 16/9535; G06F 16/9538; G06F 16/9032; G06F 40/40; G06F 40/279; G06F 40/30

(52) U.S. Cl. CPC G06Q 30/0203; G06Q 10/101; G06F 16/9535; G06F 16/9538; G06Q 50/18; G06F 40/40; G06F 40/279; G06F 40/30; G06F 16/90332

(57) ABSTRACT

The use of one or more natural language processing techniques to identify and match past question and reply sets to new question and reply sets and automate the process end to end delivered through a hypertext/cloud extension or embedded in desktop software, such as Microsoft Excel browser.

### RELATED APPLICATION

This application claims priority to U.S. Provisional Application Ser. No. 62/931,986 (entitled Automated Questionnaire Population, filed Nov.7, 2019) which is incorporated herein by reference.

### BACKGROUND

Life is full of questions. Companies will often send out a request for quote that contains many questions posed to potential vendors. Vendors spend copious amounts of unreimbursed time in reading the questions, researching for data to use in creating responses to the questions, and editing the responses.

Some browsers already support filling in discrete data, such as phone numbers, credit card information, physical addresses, and email addresses. However, such systems rely on a user beginning to type information and using autocomplete or recognize fields for discrete well defined pieces of information, like an address, credit card number, or phone number.

### SUMMARY

A response system utilizes one or more natural language processing techniques to identify and match past question and reply sets to new question and reply sets. The system automates the process end to end delivered through a hypertext/cloud. extension or embedded in desktop software.

### BRIEF DESCRIPTION OF THE DRAWINGS

FIG. 1 is a block diagram of operation of a response system according to an example embodiment.

FIG. 2 is a block diagram representation of a user interface, referred to as a response system dashboard according to an example embodiment.

FIG. 3 is a screen shot representation of an example dashboard according to an example embodiment.

FIG. 4 is an enlarged view of a dashboard question column according to an example embodiment.

FIG. 5 is an enlarged view of a dashboard type column and response column according to an example embodiment.

FIG. 6 is an enlarged view of a dashboard sidebar according to an example embodiment.

FIG. 7 is a view that illustrates one example of automatically filling in responses based on the search for each of multiple designated questions via the dashboard according to an example embodiment.

FIG. 8 is a flowchart illustrating a method of automatically filling in forms and questionnaires according to an example embodiment.

FIG. 9 is a block schematic diagram of a computer system for implementing a response system according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage deice such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Some browsers already support filling in discrete data, such as phone numbers, credit card information, physical addresses, and email addresses. However, such systems rely on a user beginning to type information and using autocomplete or recognize fields for discrete well-defined pieces of information, like an address, credit card number, or phone number. These systems are unsuitable for questions that are more open ended and can be asked in a number of different ways, such as questions commonly found in requests for quote, vendor audits, cyber security questionnaires, and many other types of communications designed to collect information about companies and individuals.

In various embodiments, one or more natural language processing techniques are used in a response system to identify and match past question and reply sets to new question and reply sets and automate a process of replying to questions end to end delivered through a hypertext/cloud extension or embedded in desktop text based presentation program, such as Microsoft Excel, Microsoft Word, or a web browser. Prior question and response sets are loaded into the response system as well as a current question set. A user interface dashboard is provided to show the question set and provide areas for reply and reply suggestions based at least on prior replies to similar questions.

In addition to supporting the organic development of the question and reply data by population from prior responses, the data can be curated to add a variety of feature sets accessible via the dashboard, including but not limited to identification of responses that have had prior organizational approval, set times for updating responses, and limiting the user control over editing the data.

The question and reply data may be stored in a master response repository, also referred to as a knowledgebase. Knowledgebase development and management includes one or more of the following:

1. Users with appropriate roles can add data to the knowledge base.

2. Knowledgebase additions can remain in an “unapproved” state until users with appropriate roles approve the knowledge base additions.

3. Once #2 is complete, knowledgebase items become available through applications, such as an Airlink application.

4. Each knowledge base item has an associated create date and organizational specific expiration/needs review date. Once this date is reached, users responsible for this knowledge base item are notified that this item is expired.

5. Entire knowledge base is analyzable along various grouping criteria within a dashboard. E.g. Show me all related questions to this question; show me all knowledge base items for this tag or set of tags; show me the most used knowledge base items etc.

The response system may be applied to the redlining process of contract drafting and negotiation in further embodiments by recognizing contract clauses and finding similar clauses that have been acceptable to a user in past contracts. Additional use cases and examples include legal contracts redline comparisons against approved redline lists, RFP Completion, organizational knowledge discovery in documents such as vendor contracts, organizational presentations, development roadmaps etc., and policy verification.

FIG. 1 is a block diagram of operation of a response system 100. A user 110 sends to the response system 100 a question or group of questions 115 in any text format via an extension. The response system 100 processes the question(s) at 120 by removing stop words [commonly used words], lemmatizing and stemming information containing words, rejoining into an information rich query with question intention, referred to as a more-like-this query 125.

Stemming and Lemmatization are Text Normalization (or sometimes called Word Normalization) techniques in the field of Natural Language Processing that may be used to prepare text, words, and documents for further processing. Stemming is the process of reducing inflection in words to their root forms such as mapping a group of words to the same stem even if the stem itself is not a valid word in the Language. Lemmatization, unlike Stemming, reduces the inflected words properly ensuring that the root word belongs to the language. In Lemmatization root word is called Lemma. A lemma (plural lemmas or lemmata) is the canonical form, dictionary form, or citation form of a set of words. Root word conversion examples include:

(stemming): [process, processes], [helpers, helper, help], [invited, invite]

Acronym Examples: [“SOC”, “SOC2”, “SSAE”], [“APT”, “Advanced Persistent Threat”], [“DLP”, “Data Loss Prevention”], [“HIPAA”, “Health Insurance Portability and Accountability Ace”], [“IDS”, “Intrusion Detection”], [“IDP”, “Intrusion Detection and Prevention”], [“ISO”, “International Organization for Standardization”]

The information rich query 125 is submitted to a natural language processing (NLP) search engine 130 and requests “more-like-this” results.

The NLP search engine 130, such as elastic, lucene, or solar is used on a knowledge base 135 to identify past responses to questionnaires and/or assessments and populate new questionnaires or assessments 140 with these responses. The questions and responses may be provided to a user interface 145 to display the questions and responses as well as interact with the questions and select responses.

A user may select a question in a questionnaire that has been added to Excel or a Browser, providing a user view of questions in the questionnaire in a question column. Other systems may be used in further embodiments.

FIG. 2 is a block diagram representation of a user interface, referred to as a response system dashboard 200. The dashboard 200 shows the questions in a first column 210, allowing the user to select a question to respond to via common cursor control and selection mechanisms. A type of question is noted in the next column 215, either open, or closed. A closed question is likely to have a discrete response, such as a number or a yes or no response. An open question may have a longer answer to it without a direct need for a discrete response. The next column 220 has the proposed response for each question in column 210. Note that column 220 may be empty immediately following loading of the questions.

A first question 222 may read: “Please describe how you authenticate users. If passwords are used, describe complexity requirements, and how passwords are protected. If SSO is supported, please describe the available options.” The question 222 has been selected by the user by clicking on the question. A help sidebar 224 may also be provided. The question asked is repeated, followed by a list of similar prior questions QA, QB and corresponding actions or responses RA, RB as indicated at 226 and 228 respectively.

FIG. 3 is a screen shot representation of an example dashboard 300. Further figures are provided that illustrate portions of dashboard 300 in enlarged views. The current screen shot shows a small number of questions related to a vendor security assessment questionnaire. Subgroups of questions shown in dashboard 300 are but a few of the subgroups that may be found in the example questionnaire. The subgroups shown include 32 Authentication, 33 Role Based Access Control, 34 Audit logging, 35 Data Retention, 36 Change Management, and 37 API management. Each subgroup contains multiple questions as shown column 310. A type of question, such as an open or closed designation for each question is shown in column 315. A portion of an answer column 320 is shown with portions of answers. A window or sidebar 325 shows a question 330 that has been selected from question column 310. Note that reference number 330 is used for both the question in the column of questions and in the sidebar 325. The question is repeated at 335 and similar questions generated from the search engine are shown at 340 and 345, along with corresponding answers. Fields are also provided for comments 350 and tags 355.

FIG. 4 is an enlarged view of question column 310. Sample questions are provided in the different subgroups. Note that some questionnaires may include hundreds of questions, many of which are open ended questions that require more text than yes or no, or a fact or two commonly required by closed ended questions. Similar open-ended questions may be asked in many different types of surveys. Having the ability to convert the questions into information rich queries with intentions provides a unique ability to find and utilize previous answers to like open ended questions.

FIG. 5 is an enlarged view of type column 310 and response column 320. Open ended questions are designated with an “O” in column 320, while closed ended questions are designated with a “C”. The corresponding answers reflect the type of question, with closed ended questions having responses of “Yes” and “No”, while open ended questions have a longer description as seen at 510 “Default is password with SMS-based TFA . . . ”, 515 “Web Server Logs Application Server Logs . . . ”, and 520 “Encrypted”.

FIG. 6 is an enlarged view of sidebar 325 with more easily readable text of questions, like questions found in the search 340 and 345, respective associated answers 610 and 615, as well as the comment 350 and tag 355 fields for each question and answer pair. In one embodiment, a user may click on an associated answer 610 or 615 to copy the answer into the response column 320. Other selection methods may also be used. The selection may be performed in response to the user, having read both the question, and the like questions and associated answers, determines that one of the answers is the most appropriate. Note that in further embodiments the most closely matching questions found in the search may be used to automatically populate the response column with the associated answers.

FIG. 7 illustrates one example of automatically filling in responses based on the search for each of multiple designated questions. At 710, several questions are shown as selected. An autofill mode has also been selected at 715, resulting in the searching based on the selected questions and the automatic filling of the response column for such questions with highest ranking answer from the retrieved question and answer pairs. Sidebar 325 also provides user selectable options for the maximum number of search results at 720, currently set to 3, as well as a checkbox 730 to autofill for new questions on copying of questions into question column 310, and an option 735 to populate new question tags with current tag filters as described later.

FIG. 8 is a flowchart illustrating a method 800 of automatically filling in forms and questionnaires. Note that this diagram omits potential workflow operations such that “user” could be an individual user or a plurality of users, each with similar roles or each having different roles. For example, User A could be permitted to accept recommended responses only while User B could be permitted to create new responses as well as accepting existing recommended responses.

Method 800 begins at operation 810. Content of a current questionnaire is read as individual questions and stored at operation 814. For each question at operation 818, a master response repository of past questions and corresponding answers is searched using a variety of search and natural language processing techniques that are known in the art to identify potential response.

Potential responses are further filtered based on response annotations at operation 822. At operation 824, if a response is identified with sufficient goodness-of-fit, the response is inserted into the master response worksheet (as shown in the dashboard) for the selected question. Runner-up response to the question are maintained to provide additional options for the user at operation 824. At decision operation 826, if all the potential response has not been identified for all questions, processing returns to operation 818 for further interrogation of the mast response repository. This returning continues until all questions have responses. In further embodiments, such as when returning to a questionnaire, a single question may be processed, such that operation 826 is not needed.

Once responses for all questions have been identified as determined at decision operation 826, the user is presented at operation 830 with a draft completed questionnaire with recommended responses in one embodiment. The presentation may be provided via the dashboard. At operation 834, the user may review each question and modify the answers, select a different displayed answer, or in some embodiments, select an initial answer if the user prefers not to have answers prefilled in by operation 830.

If a current user selected question has a recommended response at decision operation 838, decision operation 842 asks the user if they agree with the response. If not, runner-up responses may be displayed. Decision operation 846 then asks if the runner-up response is acceptable to the user. If yes, the user selects and approves the alternate runner-up response at operation 850.

If at decision operation 838, the question did not have a recommended response, operation 854 allows the user to create a new response. Note that the user may alternatively select a runner up response at 850. If at operation 842, the user did agree with the recommended response operation 858 indicates that the user has approved the response. Operations 850, 854, and 858 all feed the corresponding responses approved or created by the user to operation 860 where the system records the original question and response in the master response repository for retrieval and sending to an originator of the questionnaire, and for use in answering future questionnaires.

In one embodiment, a user submits question(s) to the system 100, which in turn searches for similar questions in the knowledge repository for the user's organization. The response system searches the knowledge base for similar questions and corresponding answers as shown in the sidebar.

In one embodiment, matching questions are returned using a preconstructed Elasticsearch index for the user's organization's knowledge base.

The user selects the most appropriate match and uses the returned answer to complete the questionnaire. A click to copy button as shown above is provided with each response to similar questions, allowing the user to click the copy button to copy it into the clipboard, or to place directly in the response column 320 as a proposed answer to the current question. Alternatively, the user can select to auto-populate the matching responses in a questionnaire. This may be accomplished by using the top rated result for each question and automatically copying it to the proposed response column for each corresponding question.

More detailed step-by-step process:

1. Client submits questionnaire in a native format document, such as a Microsoft Excel document, Microsoft Word document, PDF document, Web-based questionnaire, or similar.

2. Query input (question, tags, number of results to return) by client via Airlink App.

3. Synonym detection through a ProcessBolt synonym list with domain specific acronyms.

4. Stopword elimination through a ProcessBolt stopword domain specific list. Example stopwords are show in TABLE 1 below.

5. Query construction with synonyms and without stopwords.

6. Query length calculation determines which type of query is used—exact (short, acronyms, single words) or fuzzy (long, sentences, sentences with intent).

7. If tag(s) supplied in #1, query construction with tags and #5.

8. Addition of usage count weight to query.

9. Send query to search engine.

10. Results verified against tag criteria and number of results requested in #1.

11. Results served to customers.

12. User can select to query on question or question and answer or answer using #1 to #10 above.

13. User selects the relevant question/answer from the list returned in #10/#11.

14. Alternatively, user can select to auto-populate the matching responses in a questionnaire.

15. Airlink notifies back end ProcessBolt server on which question and/or answer user selected. ProcessBolt server ups the usage count for that question and answer set (used in #7).

16. Airlink notifies which user selected the question/answer set (used in ProcessBolt for dashboard and analytics).

17. If no answer from #10 is used by user, user is presented with an opportunity to add a new question answer set within Airlink.

The Following TABLE 1 shows example stopwords that may be tailored to each domain:
a able about above according accordingly across actually after afterwards again against all allow allows almost alone along already also although always am among amongst an and another any anybody anyhow anyone anything anyway anyways anywhere apart appear appreciate appropriate are around as aside ask asking associated at available away awfully be became because become becomes becoming been before beforehand behind being believe below beside besides best better between beyond both brief but by came can cannot cant cause causes certain certainly change changes clearly co corn come comes concerning consequently consider considering contain containing contains corresponding could couldnt course currently datum definitely description described describe despite detail did didnt different do does doesnt doing don done dont down downwards during each edu eg eight either else elsewhere enough entirely especially et etc even ever every everybody everyone everything everywhere ex exactly example except far few fifth first five followed following follows for former formerly forth four from further furthermore get gets getting given gives go goes going gone got gotten greetings had hadnt happens hardly has hasn't have havent having he hello help hence her here hereafter hereby herein hereupon hers herself hi him himself his hither hopefully however i ie if include includes ignored immediate in inasmuch inc indeed indicate indicated indicates inner insofar instead into inward is isnt it its itself just keep keeps kept know known knows last lately later latter latterly least less lest let lets like liked likely little look looking looks ltd mainly manage maintain maintained many may maybe me mean meanwhile merely might more moreover most mostly much must my myself name namely nd near nearly necessary need needs neither never nevertheless new next nine no nobody non none noone nor normally not nothing novel now nowhere obviously of off often oh ok okay old on once one ones only onto or other others otherwise ought our ours ourselves out outside over overall own part particular particularly per perhaps placed please plus possible presumably probably provide provides perform que quite qv rather rd re really reasonably regarding regardless regards relatively respectively right said saw say saying says second secondly see seeing seem seemed seeming seems seen self selves sensible sent serious seriously seven several shall she should shouldn't since six so some somebody somehow someone something sometime sometimes somewhat somewhere soon sorry specified specify specifying still sub such sup sure t take taken tell tends th than thank thanks thanx that thats thats the their theirs them themselves then thence there thereafter thereby therefore therein theres theres thereupon these they think this thorough thoroughly those though three through throughout thru thus to together too took toward towards tried tries truly try trying twice two un under unfortunately unless unlikely until unto up upon us useful usually value various very via viz vs want wants was wasn't way we welcome well went were werent whatever whence whenever whereafter whereas whereby wherein whereupon wherever whether while whither whoever whole whom will willing wish with within without wonder wont would wouldnt yes yet you your yours yourself yourselves

In one embodiment, extensions for applications, such as Google Chrome browser, Microsoft Excel, and Microsoft Word programs may be provided to query questions from a spreadsheet, Word document, or web-based assessment.

The response system may utilize Add-ins for applications to allow access to the response system from within the application in order to complete questionnaires that have been loaded into the applications. In one embodiment, a response system valid account, user name, such as an email address, a password, and response system ID may be used to utilize the Add-in capabilities.

When the add-in is used, the add-in can read and make changes to the document/questionnaire and send data over a network such as the Internet. The add in may be thought of as an extension that can be added/installed to a browser to your browser, such as a Chrome Browser. Once installed, the extension can be used in any new tab or window by simply clicking on its icon in a toolbar. The login screen for the extension will ask for your user email, password and your organization. Similar processes may be used add extensions for other applications such as Microsoft Excel and Word Queries may be performed using response system APIs. Example APIs may include

TABLE 1

| | |
|---|---|
| Resource | Description |

Assessment issues for assessor organizations:

| | |
|---|---|
| PUT /api/v1/assessment_issues/list | Get list of issues from this |
| assessment_issues.json | assessment |
| PUT /api/v1/assessment_issues/assessment | Given issue and assessment ID, |
| issuedetails.json | provide details. |

Assessment survey results for assessor organizations.

| | |
|---|---|
| PUT /api/v1/assessment_survey_results/list | Get list of assessment survey |
| assessment_surveys.json | ids and statuses for |
| | this org |
| PUT /api/v1/assessment_survey_results/list | Given assessment id return |
| assessment_survey_results.json | results |
| PUT /api/v1/assessment_survey_ | Given assessment id return |
| results/assessment | results |
| survey_result_details.json | |

Assessments for assessor organizations.

| | |
|---|---|
| PUT /api/v1/assessments/list_ | Get list of assessment tracking |
| assessments.json | ids for this org |
| PUT /api/v1/assessments/assessment_ | Get details of a single |
| details.json | assessment |

Organization assessment profiles for vendor organizations.

| | |
|---|---|
| PUT /api/v1/organization_assessment_ | Find matching questions and |
| profiles/vendor_auto_assess.json | answers. |
| PUT /api/v1/organization_assessment_ | Find matching questions and |
| profiles/multiple_vendor_auto_assess.json | answers. |
| POST /api/v1/organization_ | Save vendor assessment item |
| assessment_profiles/vendor | details. |
| assessment_item.json | |
| POST /api/v1/organization_ | Create a new assessment |
| assessment_profiles/create | profile question. |
| profile_item.json | |
| PUT /api/v1/organization_assessment | Get all tags for the |
| profiles/get_all_tags.json | organization. |
| PUT /api/v1/organization_ | Check if the user can create |
| assessment_profiles/can | profile item. |
| create_profile_item.json | |

Sessions, start here:

| | |
|---|---|
| POST /api/v1/users/sign_in.json | Log In. |
| DELETE /api/v1/users/sign_out.json | Log Out. |

Vendor assessment questions for vendor organizations.

| | |
|---|---|
| POST /api/v1/vendor_assessment | Post a message to a Vendor |
| questions/post_message.json | Assessment Question. |
| GET /api/v1/vendor_assessment | Checks to see if the current |
| questions/check_for_messages.json | user has any unread |
| | messages. |
| GET /api/v1/vendor_assessment | Gets any unread vendor |
| questions/get_unread_vaq_ | assessment question |
| subscriptions.json | subscriptions for the current |
| | user. |
| PUT /api/v1/vendor_assessment | Get messages for a question. |
| questions/get_messages.json | |
| PUT /api/v1/vendor_assessment | Mark a vendor assessment |
| questions/mark_as_read.json | question as read for current |
| | user. |

Vendor assessments for vendor organizations.

| | |
|---|---|
| POST /api/v1/vendor_assessments/ | Create a new vendor |
| create_vendor_assessment.json | assessment. |
| PUT /api/v1/vendor_assessments/ | Find vendor assessment by |
| find_vendor_assessment_by_source.json | source. |
| PUT /api/v1/vendor_assessments/ | Find vendor assessment by |
| find_vendor_assessment_by_uuid.json | uuid. |
| GET /api/v1/vendor_assessments/ | Get all users for current user's |
| get_all_org_users.json | organization |

Primary features of the response system may include:

1. An NLP search methodology, such as elastic, lucene or solar is used to identify past responses to questionnaires and/or assessments and populate new questionnaires or assessments with these responses.

2. Extensions for the Google Chrome browser and Microsoft Excel may be used to query questions from a spreadsheet or web-based assessment.

3. Queries are performed using response system API's

4. The API forms and sends More-like-this (MLT) queries to one of the search methodologies and matches the returned result sets with previously answered responses in the database

5. Matched questions, answers and comments are sent back via API to the Chrome Browser and Microsoft Excel extensions.

6. Users may select responses from the returned list of results to complete the new questionnaire or assessment response.

7. If a question does not match historical questions, the user is prompted to add the new question to their profile to build out the library of responses.

In addition to supporting the organic development of the data by population from prior responses, the data can be curated to add a variety of feature sets, including but not limited to identification of responses that have had prior organizational approval, set times for updating responses, and limiting the user control over editing the data.

FIG. 9 is a block schematic diagram of a computer system 900 to implement devices to perform methods and algorithms according to example embodiments. All components need not be used in various embodiments.

One example computing device in the form of a computer 900 may include a processing unit 902, memory 903, removable storage 910, and non-removable storage 912. Although the example computing device is illustrated and described as computer 900, the computing device may be in different forms in different embodiments. For example, the computing device may instead be a smartphone, a tablet, smartwatch, smart storage device (SSD), or other computing device including the same or similar elements as illustrated and described with regard to FIG. 9. Devices, such as smartphones, tablets, and smartwatches, are generally collectively referred to as mobile devices or user equipment.

Although the various data storage elements are illustrated as part of the computer 900, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 903 may include volatile memory 914 and non-volatile memory 908. Computer 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 900 may include or have access to a computing environment that includes input interface 906, output interface 904, and a communication interface 916. Output interface 904 may include a display device, such as a touchscreen, that also may serve as an input device. The input interface 906 may include one or more of a touchscreen, touchpad, mouse, keyboard, camera, one or more device-specific buttons, one or more sensors integrated within or coupled via wired or wireless data connections to the computer 900, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 900 are connected with a system bus 920.

Computer-readable instructions stored on a computer-readable medium are executable by the processing unit 902 of the computer 900, such as a program 918. The program 918 in some embodiments comprises software to implement one or more methods to search for similar questions and corresponding answers and populate responses. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 918 along with the workspace manager 922 may be used to cause processing unit 902 to perform one or more methods or algorithms described herein.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The following statements are potential claims that may be converted to claims in a future application. No modification of the following statements should be allowed to affect the interpretation of claims which may be drafted when this provisional application is converted into a regular utility application.

1. A computer implemented method comprising:
receiving a current questionnaire;
loading the current questionnaire into a text-based presentation program;
converting one or more questions in the current questionnaire into corresponding more-like-this queries;
submitting the one or more more-like-this queries to a natural language processing search engine to search a master response repository storing prior questionnaires and associated responses for responses corresponding to prior questions similar to the current questionnaire questions;
receiving from the natural language processing search engine at least a closest question and associated answer for at least one of the current questions;
providing a dashboard user interface listing the current questions and the at least closest question and associated answer received search engine; and
enabling the user to accept an associated answer from the master response repository as a proposed answer for each current question via the dashboard user interface.

2. The method of claim 1 wherein the one or more questions comprise a set of questions selected by the user via the dashboard user interface.

3. The method of claim 2 wherein generating a more-like-this query for a current question comprises:
receiving the current question;
removing stop words;
lemmatizing and stemming information containing words;
determining question intention; and
rejoining remaining text with the information containing words.

4. The method of claim 1 wherein the dashboard user interface listing comprises multiple prior questions and associated answers listed in ranked order as provided by the search engine for each current question.

5. The method of claim 1 wherein each prior questionnaire question and associated response comprises a knowledgebase item that has an associated create date, responsible user, and organizational specific expiration date.

6. The method of claim 5 wherein the responsible user is notified that a knowledgebase item expired in response to the expiration date being reached.

7. The method of claim 1 wherein the dashboard user interface further comprises a column for answers to each question, and wherein the method further comprises automatically populating the column for answers with an answer associated with the closest question.

8. The method of claim 7 and further comprising enabling the user to create a new proposed answer in the column for answers.

9. The method of claim 1 and further comprising storing the questions and proposed answers in the master response repository.

10. The method of claim 1 wherein the method utilizes extensions to interact with the text-based presentation program.

11. The method of claim 1 wherein the method is performed by code integrated with the text-based presentation program.

12. The method of claim 1 wherein the user is enabled to allow automatic acceptance of associated answers for all current questions and wherein the user is enabled to create a new proposed answer.

13. A machine-readable storage device having instructions for execution by a processor of a machine to cause the processor to perform operations to perform a method, the operations comprising:
receiving a current questionnaire;
loading the current questionnaire into a text-based presentation program;
using a natural language processing search engine to search a master response repository storing prior questionnaires and associated responses for responses corresponding to prior questions similar to the current questionnaire questions;
providing a dashboard user interface listing the current questions and at least a closest question and associated answer from the master response repository; and
enabling the user to accept an associated answer from the mast response repository as a proposed answer for each current question via the dashboard user interface.

14. The device of claim 13 wherein searching the master response repository comprises:
generating a query for each current question in the current questionnaire; and
using a natural language processing search engine to search the master response repository.

15. The device of claim 14 wherein generating a query for each current question comprises:
receiving a current question;
removing stop words;
lemmatizing and stemming information containing words; and
rejoining remaining text with the information containing words.

16. The device of claim 13 wherein the dashboard user interface listing comprises multiple prior questions and associated answers listed in ranked order as provided by the search engine.

17. The device of claim 13 wherein each prior questionnaire question and associated response comprises a knowledgebase item that has an associated create date, responsible user, and organizational specific expiration date.

18. A device comprising:
a processor; and
a memory device coupled to the processor and having a program stored thereon for execution by the processor to perform operations comprising:
receiving a current questionnaire;
loading the current questionnaire into a text-based presentation program;
using a natural language processing search engine to search a master response repository storing prior questionnaires and associated responses for responses corresponding to prior questions similar to the current questionnaire questions;
providing a dashboard user interface listing the current questions and at least a closest question and associated answer from the master response repository; and
enabling the user to accept an associated answer from the mast response repository as a proposed answer for each current question via the dashboard user interface.

19. The device of claim 18 wherein searching the master response repository comprises:
generating a query for each current question in the current questionnaire; and
using a natural language processing search engine to search the master response repository.

20. The device of claim 19 wherein generating a query for each current question comprises:
receiving a current question;
removing stop words;
lemmatizing and stemming information containing words; and
rejoining remaining text with the information containing words.
